(19) United States
(12) Patent Application Publication
(10) Pub. No.: US 2025/0096467 A1
(43) Pub. Date: Mar. 20, 2025

(54) ANTENNA DEVICE AND IC CARD HAVING THE SAME

(71) Applicant: TDK Corporation, Tokyo (JP)

(72) Inventor: Shoma KAJIKIYA, Tokyo (JP)

(73) Assignee: TDK Corporation, Tokyo (JP)

(21) Appl. No.: 18/889,627

(22) Filed: Sep. 19, 2024

(30) Foreign Application Priority Data
Sep. 20, 2023 (JP) 2023-151895

(51) Int. Cl. H01Q 7/00; G06K 19/077

(52) U.S. Cl. CPC H01Q 7/00; G06K 19/07775; G06K 19/07777

(57) ABSTRACT

Disclosed herein is an antenna device that includes a coil pattern having first to third winding parts each having a plurality of turns. The first winding part has an outer peripheral end being opened and an inner peripheral end connected to an outer peripheral end of the second winding part. The second winding part has an inner peripheral end connected to an outer peripheral end of the third winding part. The third winding part has an inner peripheral end being opened. Each turn of the second winding part has a first partial winding part wound concentrically with the third winding part and a second partial winding part protruding radially outward from the first partial winding part and wound about a center axis positioned between the first partial winding part and the first winding part.

### CROSS-REFERENCE TO RELATED APPLICATION

This application claims the benefit of Japanese Patent Application No. 2023-151895, filed on Sep. 20, 2023, the entire disclosure of which is incorporated by reference herein.

### BACKGROUND

The present disclosure relates to an antenna device and an IC card having the same.

JP 2012-010410A discloses in FIG. 6 an antenna device in which the innermost and second innermost turns of a coil pattern constituting an antenna are partially deformed to enhance coupling to an IC module such as a small tag.

However, in JP 2012-010410A, the coupling portion to the IC module is positioned at the end of the line length of the coil pattern, making coupling to the IC module insufficient. In addition, when the number of turns of the coil patterns is increased so as to reduce the self-resonance frequency, the coupling portion between the IC module and the coil pattern is positioned closer to the end of the line length of the coil pattern, thus further reducing the coupling.

### SUMMARY

An antenna device according to an embodiment of the present disclosure includes a substrate and a first coil pattern provided on one surface of the substrate. The first coil pattern has a first winding part, a second winding part, and a third winding part. The first winding part is wound in a plurality of turns and has an outer peripheral end being opened and an inner peripheral end connected to the outer peripheral end of the second winding part. The second winding part is wound in a plurality of turns and has an inner peripheral end connected to the outer peripheral end of the third winding part. The third winding part is wound in a plurality of turns and has an inner peripheral end being opened. Each turn of the second winding part has a first partial winding part wound concentrically with the third winding part and a second partial winding part protruding radially outward from the first partial winding part and wound about a center axis positioned between the first partial winding part and the first winding part.

### BRIEF DESCRIPTION OF THE DRAWINGS

The above features and advantages of the present disclosure will be more apparent from the following description of certain embodiments taken in conjunction with the accompanying drawings, in which:

FIG. 1 is a schematic perspective view illustrating the outer appearance of an IC card 4 having an antenna device according to a first embodiment of the present disclosure;

FIG. 2 is a schematic exploded perspective view for explaining the structure of the IC card 4;

FIG. 3 is a schematic cross-sectional view for explaining the structure of the IC card 4;

FIG. 4 is a partial cross-sectional view of the antenna device 1;

FIG. 5 is a schematic plan view for explaining the configuration of the antenna device 1;

FIGS. 6A, 6B, and 6C are enlarged views of an area B illustrated in FIG. 5, illustrating first, second, and third examples, respectively;

FIG. 7 is a schematic plan view for explaining the outer appearance of the antenna device 1;

FIGS. 8A, 8B, and 8C are schematic cross-sectional views taken along the line C-C in FIG. 5, which illustrate fourth, fifth, and sixth examples, respectively;

FIG. 9 is a schematic perspective view of the IC module 50 as viewed from the back surface side thereof;

FIG. 10 is a schematic diagram showing a state in which the IC card 4 and the card reader 7 communicate with each other;

FIG. 11 is a schematic exploded perspective view for explaining the structure of an IC card 5 having an antenna device 2 according to a second embodiment of the present disclosure;

FIG. 12 is a schematic cross-sectional view for explaining the structure of an IC card 5;

FIG. 13 is a schematic plan view for explaining the shape of the second coil pattern 200 provided on the support 60;

FIG. 14 is a schematic plan view illustrating a state where the support 20 and support 60 are put one on another; and

FIG. 15 is a schematic cross-sectional view for explaining the structure of an IC card 6 having an antenna device 3 according to a third embodiment of the present disclosure.

### DETAILED DESCRIPTION OF THE EMBODIMENTS

An object of the present disclosure is to provide an antenna device capable of achieving sufficient coupling to an external IC module even when the self-resonance frequency is reduced.

Some embodiments of the present disclosure will be explained below in detail with reference the accompanying drawings.

### First Embodiment

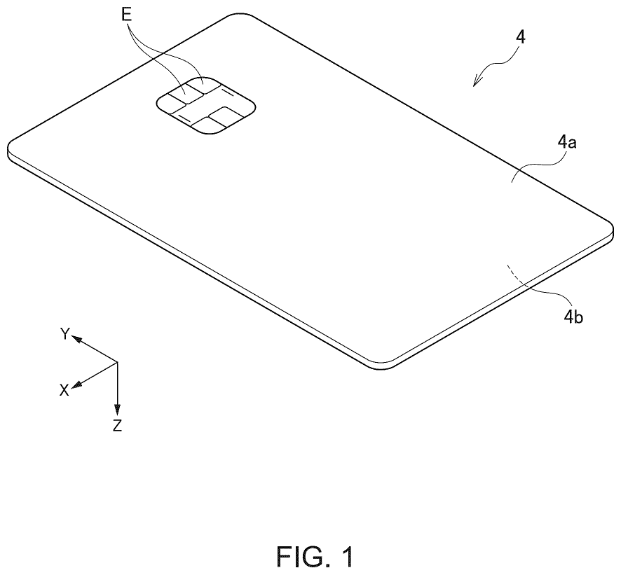

FIG. 1 is a schematic perspective view illustrating the outer appearance of an IC card 4 having an antenna device according to a first embodiment of the present disclosure.

As illustrated in FIG. 1, the IC card 4 according to the present embodiment has a plate-like shape in which the Y-, X-, and Z-directions are defined as the longer length direction, shorter direction, length and thickness direction, respectively, and has an upper surface 4a and a back surface 4b which constitute the XY surface. The IC card 4 incorporates therein an IC module to be described later whose terminal electrode E is exposed to the upper surface 4a of the IC card 4.

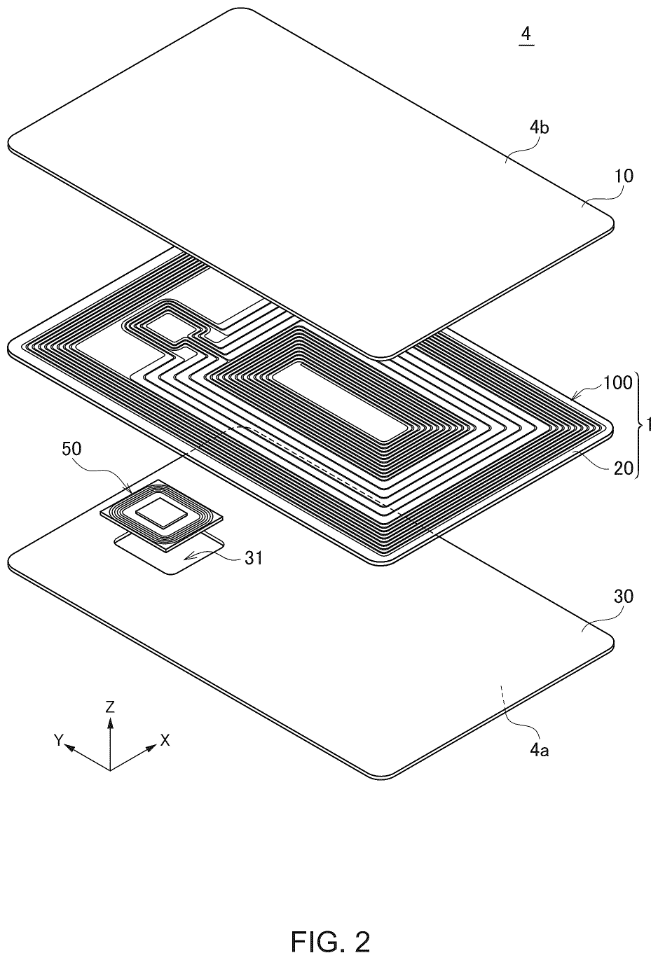

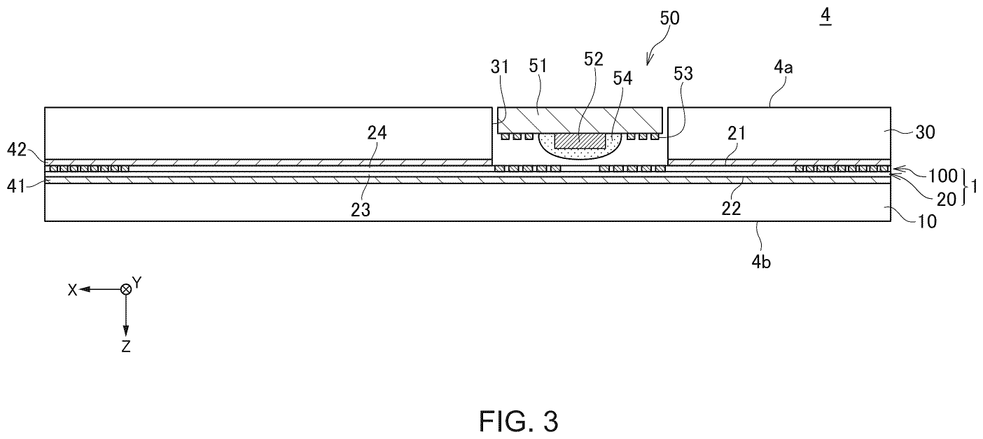

FIGS. 2 and 3 are respectively a schematic exploded perspective view and a schematic cross-sectional view for explaining the structure of the IC card 4 having an antenna device 1 according to the present embodiment.

The IC card 4 illustrated in FIGS. 2 and 3 has a structure in which a plastic plate 10, a support 20, a first coil pattern 100 supported by the support 20, and a plastic plate 30 are laminated in this order from the back surface 4b side to the upper surface 4a side. The antenna device 1 according to the present embodiment is constituted of the support 20 and first coil pattern 100. The plastic plate 10 and support 20 are stuck to each other through an adhesive layer 41, and the plastic plate 30 and support 20 are stuck to each other through an adhesive layer 42. Examples of the material of the adhesive layers 41 and 42 include an acrylic-based double-sided tape, a thermosetting resin, and a thermoplastic resin.

The plastic plates 10 and 30 are made of a resin material not preventing transmission of magnetic flux. The outer surface of the plastic plate 10 constitutes the back surface 4b of the IC card 4. The outer surface of the plastic plate 30 constitutes the upper surface 4a of the IC card 4. The plastic plates 10 and 30 may be made of a transparent resin material. The plastic plate 30 has a through hole 31 formed therein, in which an IC module 50 is disposed. A metal plate may be employed in place of the plastic plate 30. In this case, a magnetic sheet may be disposed between the support 20 and the metal plate. Further alternatively, reinforced glass may be employed in place of the plastic plates 10 and 30. In common type IC cards, the plane position of the terminal electrode E is specified by standards, etc., so that the plane position of the through hole 31 formed in the plastic plate 30 needs to comply therewith.

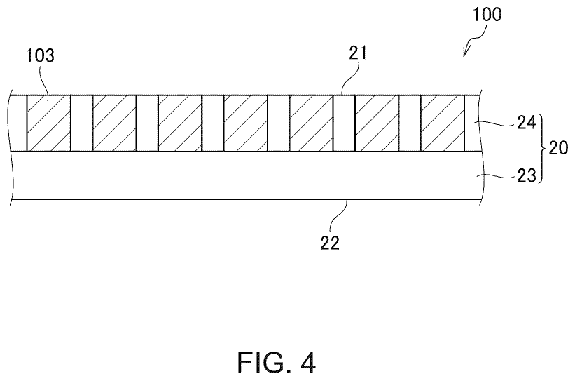

FIG. 4 is a partial cross-sectional view of the antenna device 1.

In the example illustrated in FIG. 4, the support 20 has a structure having a film-like substrate 23 made of an insulating resin material and a resin layer 24 which are laminated one on another in this order. A conductor pattern 103 constituting the first coil pattern 100 is filled in a trench formed in the resin layer 24 such that the bottom and side surfaces thereof are covered with the substrate 23 and resin layer 24, respectively. A conductive material constituting the first coil pattern 100 may be, for example, copper, aluminum, or an alloy thereof. One surface 21 of the support 20 is constituted by the resin layer 24. The substrate 23 may be made of, for example, an insulating resin material such as PET (Polyethylene Terephthalate) or PI (Polyimide). The insulating resin material constituting the substrate 23 may be a transparent one. The other surface 22 of the support 20 is constituted by the substrate 23. In the present embodiment, the conductor pattern 103 is absent on the other surface 22 side of the support 20. However, the structure of the support 20 is not particularly limited, and the support 20 may include only the substrate 23. That is, the antenna device 1 according to the present embodiment may be constituted of the substrate 23 and first coil pattern 100 provided on the surface of the substrate 23.

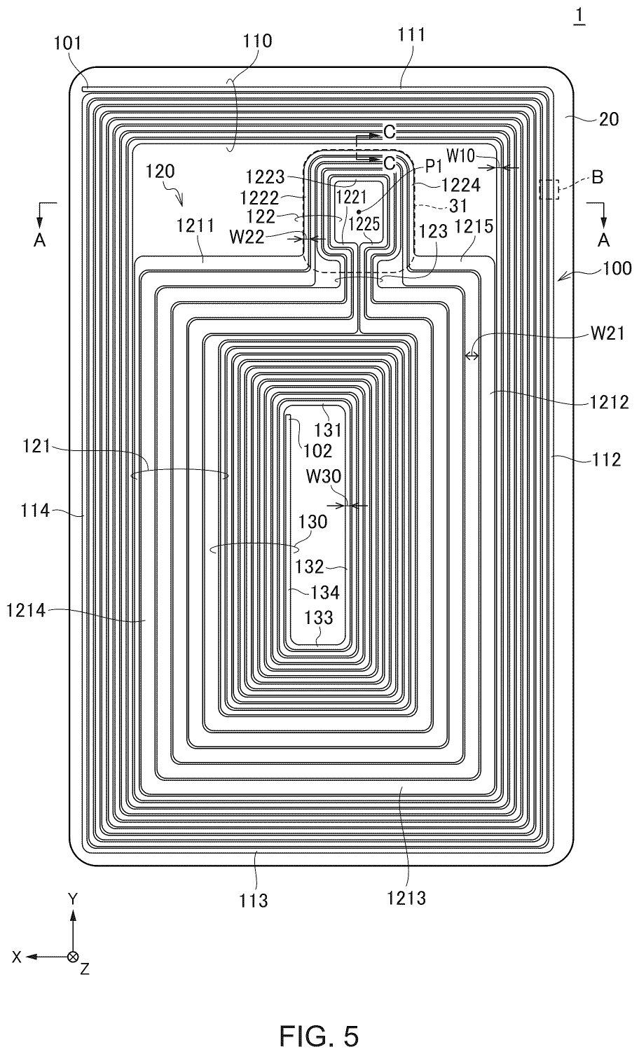

FIG. 5 is a schematic plan view for explaining the configuration of the antenna device 1 according to the present embodiment. The line A-A illustrated in FIG. 5 indicates the sectional position of FIG. 3.

As illustrated in FIG. 5, the antenna device 1 according to the present embodiment is constituted of the support 20 and first coil pattern 100. The first coil pattern 100 includes a first winding part 110 wound in a plurality of turns along the outer edge of the support 20, a second winding part 120 wound in a plurality of turns and whose outer peripheral end is connected to the inner peripheral end of the first winding part 110, and a third winding part 130 wound in a plurality turns and whose outer peripheral end is connected to the inner peripheral end of the second winding part 120. An outer peripheral end 101 of the first winding part 110 constitutes the outer peripheral end of the first coil pattern 100. An inner peripheral end 102 of the third winding part 130 constitutes the inner peripheral end of the first coil pattern 100. Both the outer and inner peripheral ends 101 and 102 are opened.

The first winding part 110 has first sections 111 and 113 extending in the X-direction and second sections 112 and 114 extending in the Y-direction. In the example illustrated in FIG. 5, the number of turns of the first winding part 110 is about eight, and the pattern width thereof is W10. When the pattern width of the first winding part 110 is not uniform, the pattern width W10 may be defined by the maximum pattern width, the minimum pattern width, or the average pattern width of the first winding part 110. The pattern width refers to the radial width of the conductor pattern 103, which is a dimension in a direction perpendicular to the thickness and extending directions of the conductor pattern.

The third winding part 130 has first sections 131 and 133 extending in the X-direction and second sections 132 and 134 extending in the Y-direction. In the example illustrated in FIG. 5, the number of turns of the third winding part 130 is about eleven. When the number of turns of the third winding part 130 positioned at the inner peripheral side is thus made larger than the number of turns of the first winding part 110 positioned at the outer peripheral side, it is possible to reduce a difference in line length between the third winding part 130 and the first winding part 110. This allows the second winding part 120 to be disposed closer to the center of the line length of the first coil pattern 100. The line length of the third winding part 130 may be almost equal to the line length of the first winding part 110. The pattern width of the third winding part 130 is W30. The pattern width W30 of the third winding part 130 may be equal to the pattern width W10 of the first winding part 110. When the pattern width of the third winding part 130 is not uniform, the pattern width W30 may be defined by the maximum pattern width, the minimum pattern width, or the average pattern width of the third winding part 130.

Each turn of the second winding part 120 has a first partial winding part 121 and a second partial winding part 122. The first partial winding part 121 is wound concentrically with the third winding part 130 in less than one turn. The second partial winding part 122 protrudes radially outward from the first partial winding part 121 and wound about a center axis P1 positioned between sections 1211, 1215 of the first partial winding part 121 and the section 111 of the first winding part 110. That is, the first partial winding part 121 of the second winding part 120 is divided in the middle and passes through the second partial winding part 122. The above concentric arrangement is not limited to a case where the axes of the winding parts strictly coincide with each other but may include a position deviation due to variations associated with manufacturing error and the like.

In the example illustrated in FIG. 5, the number of turns of the second winding part 120 is about five. When the number of turns of the second winding part 120 is thus made smaller than the numbers of turns of the first and third winding parts 110 and 130, it is possible to sufficiently ensure a pattern width W21 of the first partial winding part 121 of the second winding part 120 and thus to reduce the resistance value of the first partial winding part 121. Put another way, when the numbers of turns of the first and third winding parts 110 and 130 are made larger than the number of turns of the second winding part 120, it is possible to sufficiently ensure the line lengths of the first and third winding parts 110 and 130 and to reduce the self-resonance frequency of the first coil pattern 100.

The first partial winding part 121 of the second winding part 120 has first sections 1211, 1213, and 1215 extending in the X-direction and second sections 1212 and 1214 extending in the Y-direction. The second partial winding part 122 of the second winding part 120 has first sections 1221, 1223, and 1225 extending in the X-direction and second sections 1222 and 1224 extending in the Y-direction. In FIG. 5, the plane position of the through hole 31 formed in the plastic plate 30 is denoted by a dashed line. As illustrated in FIG. 5, the second partial winding part 122 of the second winding part 120 overlaps the through hole 31 of the plastic plate 30 in a plan view (as viewed in the Z-direction). As a result, the second partial winding part 122 of the second winding part 120 is coupled to the IC module 50 disposed in the through hole 31 of the plastic plate 30. That is, the second partial winding part 122 of the second winding part 120 functions as a coupling coil to be coupled to the IC module 50. On the other hand, the first winding part 110, the first partial winding part 121 of the second winding part 120, and the third winding part 130 function as an antenna coil to be coupled to an external card reader in actual use state. The second partial winding part 122 of the second winding part 120 may function as a part of the antenna coil to be coupled to an external card reader.

A pattern width W22 of the second partial winding part 122 of the second winding part 120 is smaller than a pattern width W21 of the first partial winding part 121 of the second winding part 120. This allows the second partial winding part 122 of the second winding part 120 to be disposed in a narrow space overlapping the through hole 31 of the plastic plate 30. Further, when the pattern width W21 is made larger than the pattern widths W10, W22, and W30, it is possible to reduce the resistance value of the first partial winding part 121 of the second winding part 120. The pattern width W22 of the second partial winding part 122 of the second winding part 120 may be equal to the pattern width W10 of the first winding part 110 or the pattern width W30 of the third winding part 130. When the pattern width of the first partial winding part 121 is not uniform, the pattern width W21 may be defined by the maximum pattern width, the minimum pattern width, or the average pattern width of the first partial winding part 121. Similarly, when the pattern width of the second partial winding part 122 is not uniform, the pattern width W22 may be defined by the maximum pattern width, the minimum pattern width, or the average pattern width of the second partial winding part 122.

The outermost turn and second outermost turn of the first partial winding part 121 of the second winding part 120 are directly connected to the second partial winding part 122 of the second winding part 120. On the other hand, the innermost turn, second innermost turn, and third innermost turn of the first partial winding part 121 of the second winding part 120 are connected to the second partial winding part 122 of the second winding part 120 through a connection part 123 extending in the Y-direction. Thus, when the outer peripheral end 101 and the inner peripheral end 102 are set as the winding start point and the winding end point, respectively, the two outer peripheral side turns of the second partial winding part 122 of the second winding part 120 are wound about the center axis P1 in the order of the sections 1222, 1223, and 1224, while the three inner peripheral side turns of the second partial winding part 122 of the second winding part 120 are wound about the center axis P1 in the order of the sections 1221, 1222, 1223, 1224, and 1225. That is, the two outer peripheral side turns directly shift from the section 1211 of the first partial winding part 121 that extends in the X-direction to the section 1222 of the second partial winding part 122 that extends in the Y-direction and directly shift from the section 1224 of the second partial winding part 122 that extends in the Y-direction to the section 1215 of the first partial winding part 121 that extends in the X-direction. On the other hand, the three inner peripheral side turns shift from the section 1211 of the first partial winding part 121 that extends in the X-direction to the section 1221 of the second partial winding part 122 that extends in the X-direction through the connection part 123 extending in the Y-direction and shift from the section 1225 of the second partial winding part 122 that extends in the X-direction to the section 1215 of the first partial winding part 121 that extends in the X-direction through the connection part 123 extending in the Y-direction.

As described above, in the present embodiment, the second winding part 120 including the second partial winding part 122 to be coupled to the IC module 50 is positioned between the first winding part 110 and the third winding part 130, so that even when the entire line length of the first coil pattern 100 is increased for the purpose of reducing the self-resonance frequency, the second winding part 120 is positioned closer to the center of the line length of the first coil pattern 100, whereby the density of current flowing through the second winding part 120 is increased.

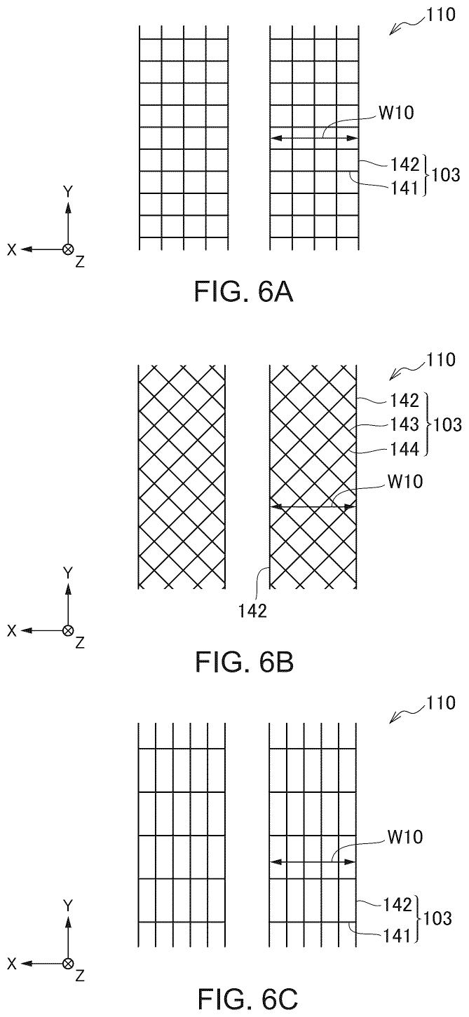

FIGS. 6A, 6B, and 6C are enlarged views of an area B illustrated in FIG. 5, illustrating first, second, and third examples, respectively. In all the examples of FIGS. 6A to 6C, the first winding part 110 is constituted of a mesh-like conductor pattern 103. Although not illustrated, the first partial winding part 121 of the second winding part 120 and the third winding part 130 may each be constituted of the same mesh-like conductor pattern 103 as the first winding part 110. On the other hand, the second partial winding part 122 of the second winding part 120 may be constituted of a solid pattern, not a mesh-like conductor pattern 103.

In the first example illustrated in FIG. 6A, the first winding part 110 is constituted of a plurality of thin line patterns 141 extending in the X-direction and a plurality of thin line patterns 142 extending in the Y-direction. By designing the widths of the thin line patterns 141 and 142 so small as to make the thin line patterns 141 and 142 difficult to visually recognize under the condition that the plastic plates 10, 30 and support 20 are transparent, the entire IC card 4 becomes substantially transparent except for the IC module 50. Further, the second partial winding part 122 of the second winding part 120 that overlaps the IC module 50 is constituted of a solid pattern, which can reduce the resistance value of the second partial winding part 122 even when the pattern width W22 is small.

The arrangement pitch of the thin line patterns 141 and the arrangement pitch of the thin line patterns 142 may be the same. In the first example of FIG. 6A, the pattern width W10 of the first winding part 110 is defined by the distance between the outer peripheral side edge of the outermost one of the thin line patterns 142 constituting each turn and the inner peripheral side edge of the innermost one thereof. In the sections 111 and 113 extending in the X-direction, the pattern width W10 of the first winding part 110 is defined by the distance between the outer peripheral side edge of the outermost one of the thin line patterns 141 constituting each turn and the inner peripheral side edge of the innermost one thereof.

In the second example of FIG. 6B, the first winding part 110 is constituted of a plurality of thin line patterns 143 extending at an angle of 45° with respect to the X-and Y-directions, a plurality of thin line patterns 144 perpendicular to the thin line patterns 143, and two thin line patterns 142 constituting the outer and inner peripheral side edges of each turn. The arrangement pitch of the thin line patterns 143 and the arrangement pitch of the thin line patterns 144 may be the same. In the second example of FIG. 6B, the pattern width W10 of the first winding part 110 is defined by the distance between the outer peripheral side edge of the outermost thin line pattern 142 and the inner peripheral side edge of the innermost thin line pattern 142. In the sections 111 and 113 extending in the X-direction, the pattern width W10 of the first winding part 110 is defined by the distance between the outer peripheral side edge of the outermost one of the thin line patterns 141 constituting each turn and the inner peripheral side edge of the innermost one thereof.

The third example illustrated in FIG. 6C differs from the first example of FIG. 6A in that the arrangement pitch of the thin line patterns 141 is larger than the arrangement pitch of the thin line patterns 142. In the sections 111 and 113 extending in the X-direction, the arrangement pitch of the thin line patterns 142 may be larger than the arrangement pitch of the thin line patterns 141. When the number of the thin line patterns extending along the winding direction of the first coil pattern 100 is increased, and the number of the thin line patterns extending along a direction perpendicular to the winding direction of the first coil pattern 100 is reduced, it is possible to reduce the resistance value of the first coil pattern while ensuring transparency.

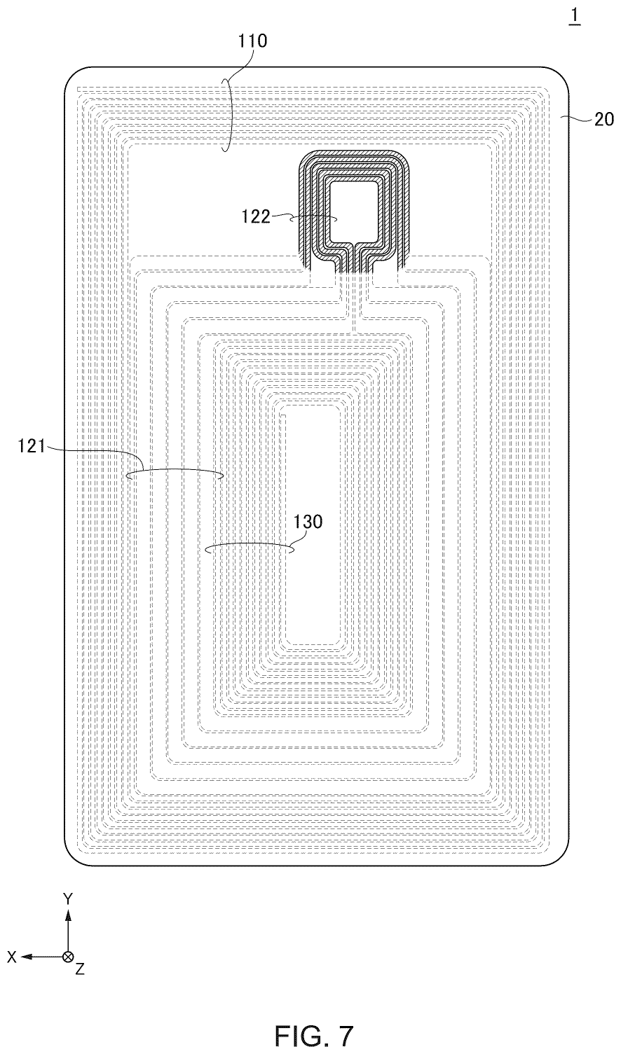

As described above, the first winding part 110, the first partial winding part 121 of the second winding part 120, and the third winding part 130 are each constituted of a mesh-like thin line pattern, and the second partial winding part 122 of the second winding part 120 is constituted of a solid pattern, whereby, as illustrated in FIG. 7, the entire antenna device 1 becomes substantially transparent except for the second partial winding part 122 of the second winding part 120 and a part of the connection part 123. Since the first winding part 110, the first partial winding part 121 of the second winding part 120, and the third winding part 130 are thus substantially transparent (difficult to visually recognize), they are denoted by dashed lines in FIG. 7.

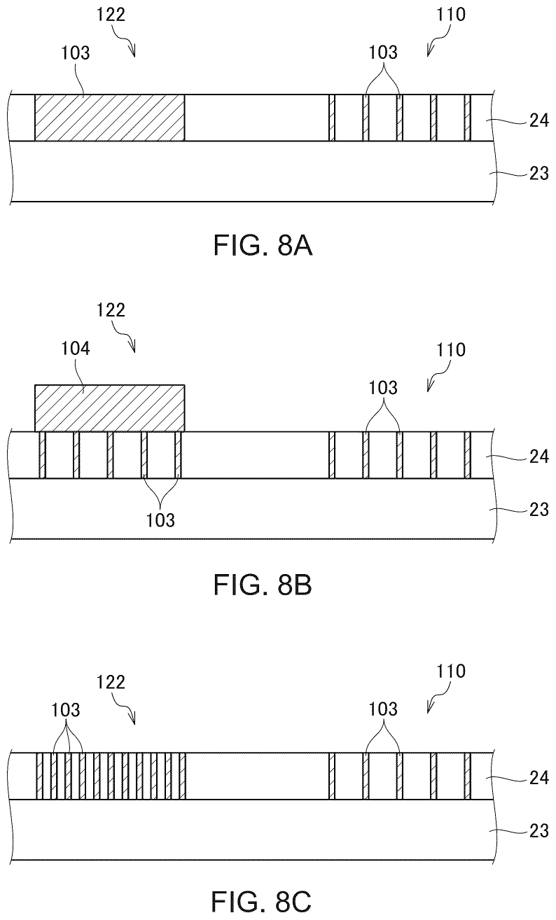

FIGS. 8A, 8B, and 8C are schematic cross-sectional views taken along the line C-C in FIG. 5, which illustrate fourth, fifth, and sixth examples, respectively.

When the second partial winding part 122 of the second winding part 120 is constituted of a solid pattern as in the fourth example illustrated in FIG. 8A, the conductor pattern 103 constituting the second partial winding part 122 may be provided on the surface of the substrate 23 so as to be filled in the trench formed in the resin layer 24. In this case, the mesh-like conductor pattern 103 constituting the first winding part 110 and the like and the solid conductor pattern 103 constituting the second partial winding part 122 of the second winding part 120 are positioned in the same layer, thereby allowing a reduction in the number of processes for forming the first coil pattern 100.

Alternatively, as in the fifth example illustrated in FIG. 8B, the second partial winding part 122 of the second winding part 120 may be constituted of a combination of the mesh-like conductor pattern 103 and a solid pattern 104 made of, e.g., silver paste. The mesh-like conductor pattern 103 is provided on the surface of the substrate 23 so as to be filled in the trench formed in the resin layer 24, and the solid pattern 104 is provided on the surface of the resin layer 24 so as to overlap the mesh-like conductor pattern 103. This allows the material and thickness of the solid pattern 104 to be desirably selected, increasing design freedom.

Alternatively, as in the sixth example illustrated in FIG. 8C, the second partial winding part 122 of the second winding part 120 may be constituted of the mesh-like conductor pattern 103. In this case, by making the pitch of the mesh patterns constituting the second partial winding part 122 smaller than the pitch of the mesh patterns constituting the first winding part 110 and the like, it is possible to reduce the resistance of the second partial winding part 122. Further, by making the thin line patterns constituting the mesh-like conductor pattern 103 have a substantially constant width, process difficulty is reduced.

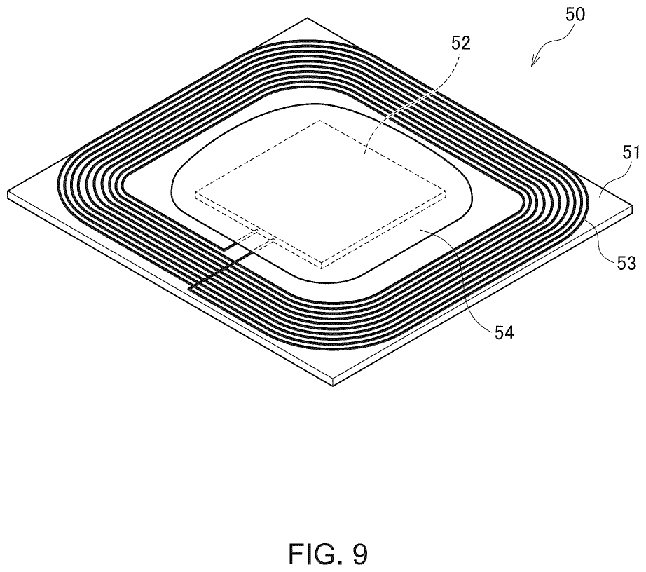

FIG. 9 is a schematic perspective view of the IC module 50 as viewed from the back surface side thereof.

As illustrated in FIG. 9, the IC module 50 includes a module substrate 51, an IC chip mounted on or incorporated in the module substrate 51, and a coupling coil 53. The IC chip 52 is protected by being covered with a dome-shaped protective resin 54. The protective resin 54 is made of an insulating member. The terminal electrode E illustrated in FIG. 1 is provided on the front surface side of the module substrate 51. The IC module 50 thus configured is accommodated in the through hole 31 formed in the plastic plate 30. In a state where the IC module 50 is accommodated in the through hole 31, the coupling coil 53 and the second partial winding part 122 of the second winding part 120 of the first coil pattern 100 are electromagnetically coupled to each other. The second partial winding part 122 of the second winding part 120 is connected to the first winding part 110, the first partial winding part 121 of the second winding part 120, and the third winding part 130 each functioning as an antenna coil, thus allowing the IC module 50 to communicate with an external device through the first coil pattern 100.

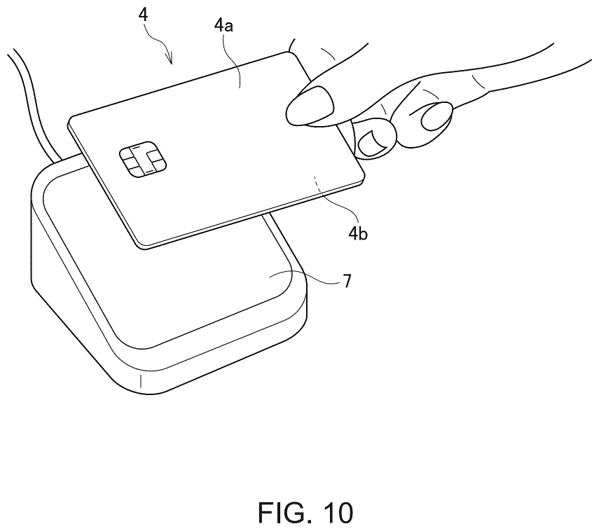

Thus, as illustrated in FIG. 10, when the upper surface 4a or back surface 4b of the IC card 4 is made to face a card reader 7, communication can be performed between the card reader 7 and the IC chip 52. That is, the card reader 7 is coupled to the coupling coil 53 of the IC module 50 through the first coil pattern 100 and can thereby communicate with the IC chip 52.

As described above, in the antenna device 1 according to the present embodiment, the second partial winding part 122 is included in the second winding part 120 positioned at substantially the center of the line length of the first coil pattern 100 and is used as a coupling coil. This increases the numbers of turns of the first and third winding parts 110 and 130, making it possible to reduce the self-resonance frequency. That is, in order for a coupling coil to be disposed so as to overlap the plane position (restricted by standards and the like) of the through hole 31, a part of the first winding part 110 may be deformed inward and used as a coupling coil; however, in this case, the coupling coil is separated apart from the center of the line length of the first coil pattern 100 to reduce the density of current flowing through the coupling coil. On the other hand, in the antenna device 1 according to the present embodiment, the coupling coil is positioned at substantially the center of the line length of the first coil pattern 100, thus making it possible to ensure a sufficient density of current flowing through the coupling coil.

Further, the first winding part 110, the first partial winding part 121 of the second winding part 120, and the third winding part 130 are each constituted of the mesh-like conductor pattern 103 and, accordingly, the entire antenna device 1 becomes transparent except for the second partial winding part 122 of the second winding part 120. Thus, when the transparent plastic plates 10 and 30 are used to sandwich the antenna device 1 according to the present embodiment, there can be provided a transparent IC card. In addition, the IC card 4 has a simple structure in which the support 20 is sandwiched by the two plastic plates 10 and 30, facilitating a reduction in the entire thickness thereof.

### Second Embodiment

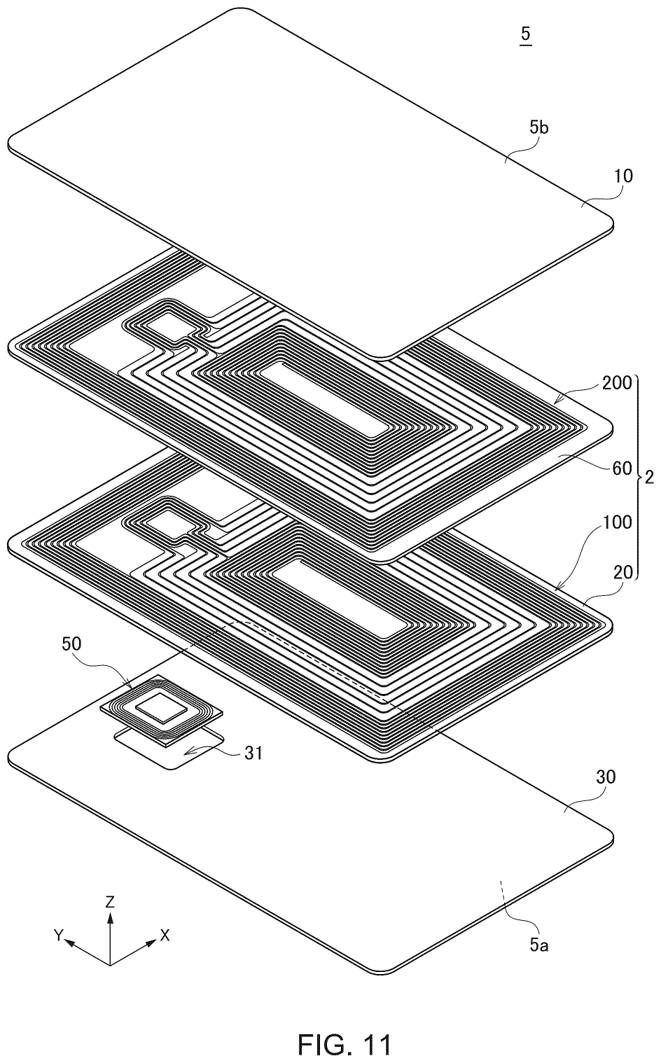

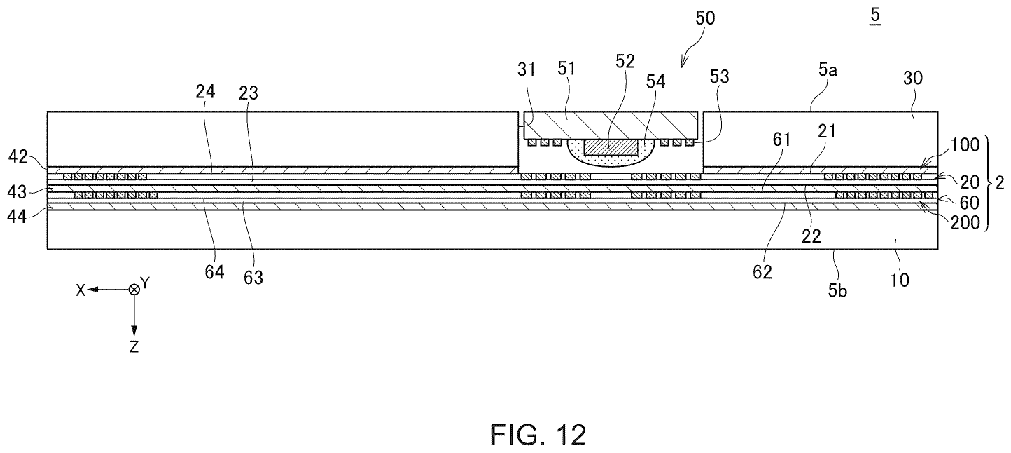

FIGS. 11 and 12 are respectively a schematic exploded perspective view and a schematic cross-sectional view for explaining the structure of an IC card 5 having an antenna device 2 according to a second embodiment of the present disclosure.

The IC card 5 illustrated in FIGS. 11 and 12 has a structure in which a plastic plate 10, a support 60, a second coil pattern 200 supported by the support 60, a support 20, a first coil pattern 100 supported by the support 20, and a plastic plate 30 are laminated in this order from a back surface 5b side to an upper surface 5a side. The outer surface of the plastic plate 10 constitutes the back surface 5b of the IC card 5, and the outer surface of the plastic plate 30 constitutes the upper surface 5a of the IC card 5.

The antenna device 2 according to the present embodiment is constituted of the supports 20, 60 and the first and second coil patterns 100, 200. The plastic plate 30 and support 20 are stuck to each other through an adhesive layer 42. The support 20 and support 60 are stuck to each other through an adhesive layer 43. The plastic plate 10 and support 60 are stuck to each other through an adhesive layer 44. Like the support 20, the support 60 may have a structure in which a substrate (substrate 63) and a resin layer (resin layer 64) are laminated one on another. In this case, the second coil pattern 200 may be filled in a trench formed in the resin layer 64 constituting one surface 61 of the support 60. No conductor pattern is present on the other surface 62 of the support 60. Other basic configurations are the same as those of the IC card 4 according to the first embodiment, so the same reference numerals are given to the same elements, and overlapping description will be omitted.

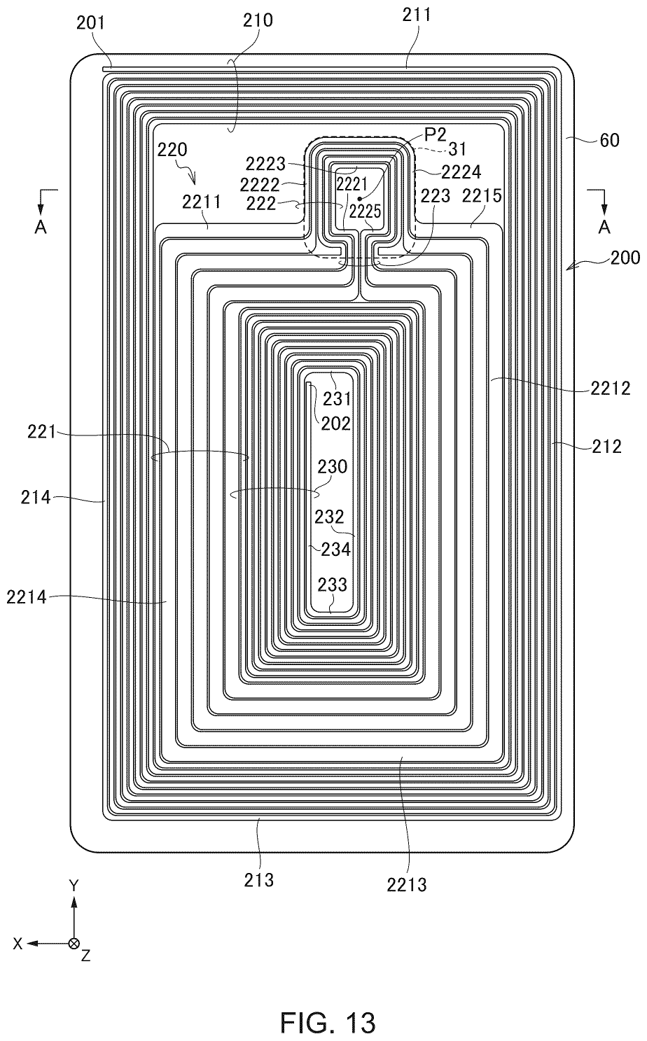

FIG. 13 is a schematic plan view for explaining the shape of the second coil pattern 200 provided on the support 60. The line A-A illustrated in FIG. 13 indicates the sectional position of FIG. 12.

As illustrated in FIG. 13, the second coil pattern 200 provided on the support 60 has substantially the same pattern shape as the first coil pattern 100 illustrated in FIG. 5. That is, the second coil pattern 200 includes a fourth winding part 210 wound in a plurality of turns along the outer edge of the support 60, a fifth winding part 220 wound in a plurality of turns and whose outer peripheral end is connected to the inner peripheral end of the fourth winding part 210, and a sixth winding part 230 wound in a plurality of turns and whose outer peripheral end is connected to the inner peripheral end of the fifth winding part 220. The number of turns of the fourth winding part 210 is the same as the number of turns of the first winding part 110, the number of turns of the fifth winding part 220 is the same as the number of turns of the second winding part 120, and the number of turns of the sixth winding part 230 is the same as the number of turns of the third winding part 130. Further, sections 211 to 214 constituting the fourth winding part 210 are the same in length and extending direction as their corresponding sections 111 to 114 constituting the first winding part 110, and sections 231 to 234 constituting the sixth winding part 230 are the same in length and extending direction as their corresponding sections 131 to 134 constituting the third winding part 130.

The fifth winding part 220 has a third partial winding part 221 corresponding to the first partial winding part 121 and a fourth partial winding part 222 corresponding to the second partial winding part 122. When an outer peripheral end 201 and an inner peripheral end 202 are set as start and end points, respectively, the third partial winding part 221 is wound about a center axis P2 in the order of sections 2211, 2222, 2223, 2224, and 2225. The sections 2211 to 2215 constituting the third partial winding part 221 are the same in length and extending direction as their corresponding sections 1211 to 1215 constituting the first partial winding part 121. The pattern shape of the fourth partial winding part 222 and the pattern shape of the second partial winding part 122 coincide with each other. Thus, when the first and second coil patterns 100 and 200 are put one on another so as to overlap each other, the plane positions of the sections 1221 to 1225 constituting the second partial winding part 122 and the plane positions of the sections 2221 to 2225 constituting the fourth partial winding part 222 coincide with each other, respectively.

The fourth winding part 210, fifth winding part 220, and sixth winding part 230 may each be constituted of a mesh-like conductor pattern. Among them, the fourth partial winding part 222 of the fifth winding part 220 may be constituted of a solid pattern, not a mesh-like conductor pattern. Alternatively, both the second partial winding part 122 of the second winding part 120 and the fourth partial winding part 222 of the fifth winding part 220 may be constituted of a solid pattern or a mesh-like conductor pattern. Further alternatively, one of the second partial winding part 122 of the second winding part 120 and the fourth partial winding part 222 of the fifth winding part 220 may be constituted of a mesh-like conductor pattern and the other one thereof may be constituted of a solid pattern.

The outer peripheral end 201 of the fourth winding part 210 constitutes the outer peripheral end of the second coil pattern 200. The inner peripheral end 202 of the sixth winding part 230 constitutes the inner peripheral end of the second coil pattern 200. Both the outer and inner peripheral ends 201 and 202 are opened.

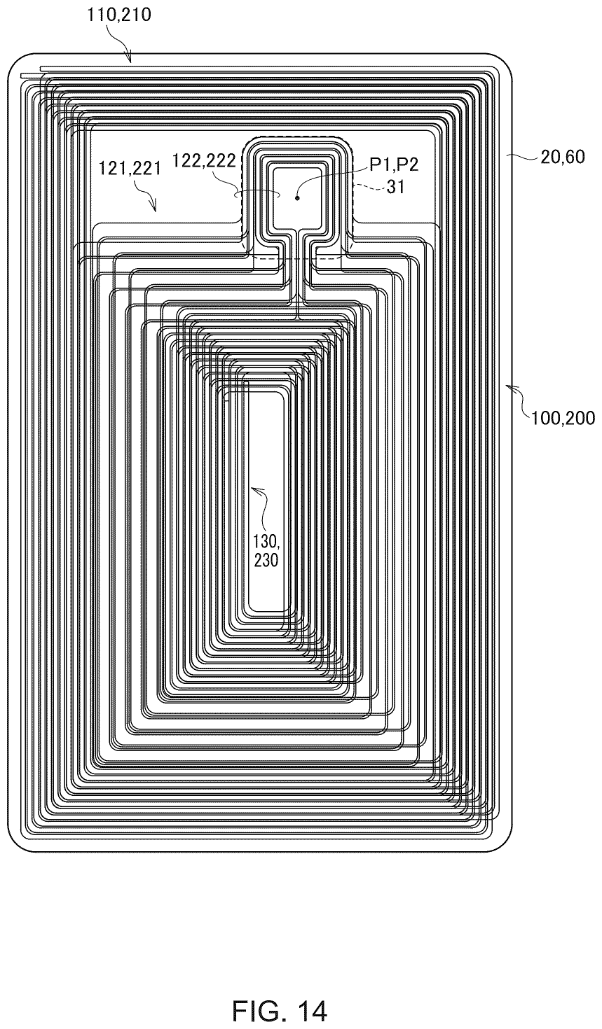

FIG. 14 is a schematic plan view illustrating a state where the support 20 and support 60 are put one on another.

As illustrated in FIG. 14, the second coil pattern 200 has substantially the same pattern shape as the first coil pattern 100; however, when the first and second coil patterns 100 and 200 are put one on another such that the center axis P1 of the second partial winding part 122 of the second winding part 120 and the center axis P2 of the fourth partial winding part 222 of the fifth winding part 220 coincide with each other, the center axes of the first and fourth winding parts 110 and 210 are misaligned, and the center axes of the third and sixth winding parts 130 and 230 are misaligned. Note that the center axis P1 of the second partial winding part 122 of the second winding part 120 and the center axis P2 of the fourth partial winding part 222 of the fifth winding part 220 need not strictly coincide with each other but may be slightly misaligned due to variations associated with manufacturing error and the like.

In the example illustrated in FIGS. 5, 13, and 14, axis of the fourth winding part 210 is the center misaligned with the center axis of the first winding part 110 in the negative X-direction and positive Y-direction, and the center axis of the sixth winding part 230 is misaligned with the center axis of the third winding part 130 in the negative X-direction and positive Y-direction. To achieve this, the plane positions of the fourth winding part 210, the third partial winding part 221 of the fifth winding part 220, and the sixth winding part 230 that constitute the second coil pattern 200 are respectively misaligned with the plane positions of the first winding part 110, the first partial winding part 121 of the second winding part 120, and the third winding part 130 that constitute the first coil pattern 100 in the negative X-direction and positive Y-direction as a whole.

Since the plane positions of the first and second coil patterns 100 and 200 are thus misaligned, resonance caused by the first coil pattern 100 and resonance caused by the second coil pattern 200 interfere with each other, with the result that the self-resonance frequency is separated into two frequencies. One of the two self-resonance frequencies is lower than the self-resonance frequency caused by the first coil pattern 100 alone, and the other one thereof is higher than the self-resonance frequency caused by the first coil pattern 100 alone. That is, it is possible to obtain a lower self-resonance frequency when the plane positions of the two coil patterns 100 and 200 are misaligned. The direction of the misalignment between the plane positions of the first and second coil patterns 100 and 200 may be one of the X-and Y-directions; however, when the plane positions thereof are misaligned in both the X-and Y-direction, it is possible to obtain a low self-resonance frequency with a smaller misalignment amount.

As described above, in the present embodiment, the two independent first and second coil patterns 100 and 200 are put one on another, so that it is possible to obtain a lower self-resonance frequency. In addition, the first and second coil patterns 100 and 200 are provided on different supports 20 and 60, which facilitates design change.

### Third Embodiment

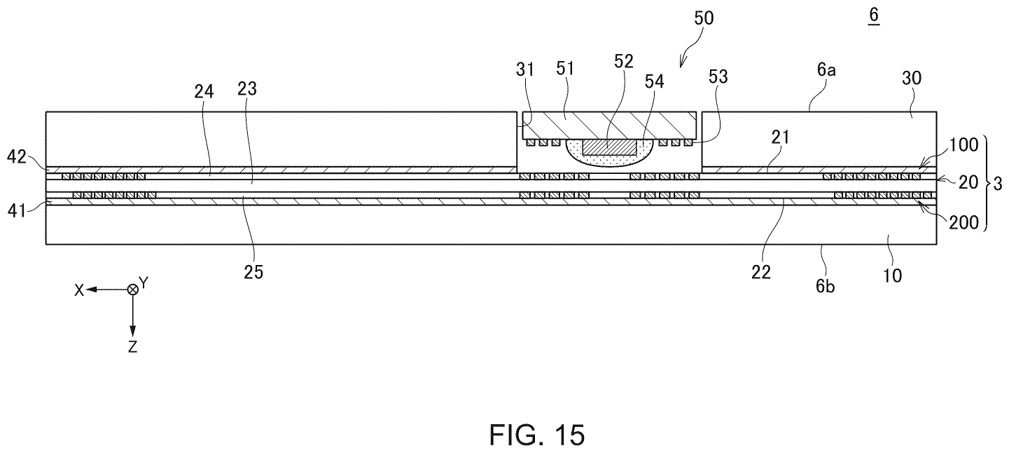

FIG. 15 is a schematic cross-sectional view for explaining the structure of an IC card 6 having an antenna device 3 according to a third embodiment of the present disclosure.

The IC card 6 illustrated in FIG. 15 differs from the IC card 5 according to the second embodiment in that the support 60 is excluded and that the second coil pattern 200 is supported on the other surface 22 of the support 20. That is, in the present embodiment, the first and second coil patterns 100 and 200 are respectively provided on one and the other surfaces of the substrate 23 and respectively filled in trenches formed in the resin layers 24 and 25. Other basic configurations are the same as those of the IC card 5 according to the second embodiment, so the same reference numerals are given to the same elements, and overlapping description will be omitted. In the present embodiment, the outer surface of the plastic plate 10 constitutes a back surface 6b of the IC card 6, and the outer surface of the plastic plate 30 constitutes an upper surface 6a of the IC card 6.

The fourth winding part 210, fifth winding part 220, and sixth winding part 230 may each be constituted of a mesh-like conductor pattern. Among them, the fourth partial winding part 222 of the fifth winding part 220 may be constituted of a solid pattern, not a mesh-like conductor pattern. Alternatively, both the second partial winding part 122 of the second winding part 120 and the fourth partial winding part 222 of the fifth winding part 220 may be constituted of a solid pattern or a mesh-like conductor pattern. Further alternatively, one of the second partial winding part 122 of the second winding part 120 and the fourth partial winding part 222 of the fifth winding part 220 may be constituted of a mesh-like conductor pattern and the other one thereof may be constituted of a solid pattern.

In the present embodiment, the first and second coil patterns 100 and 200 are respectively provided on the front and back of the support 20, so that the entire thickness can be reduced. In addition, not only that the relation between the plane positions of the first and second coil patterns 100 and 200 is fixed, but also that the misalignment between the center axes of the first and fourth winding parts 110 and 210 and the misalignment between the center axes of the third and sixth winding parts 130 and 230 can be designed with high accuracy. Thus, even when the first and second coil patterns 100 and 200 are each mostly constituted of a mesh-like conductor pattern, interference fringes due to variations in the misalignment are unlikely to occur, making it possible to maintain fine transparent appearance.

While some embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

An antenna device according to an embodiment of the present disclosure includes a substrate and a first coil pattern provided on one surface of the substrate. The first coil pattern has a first winding part, a second winding part, and a third winding part. The first winding part is wound in a plurality of turns and has an outer peripheral end being opened and an inner peripheral end connected to the outer peripheral end of the second winding part. The second winding part is wound in a plurality of turns and has an inner peripheral end connected to the outer peripheral end of the third winding part. The third winding part is wound in a plurality of turns and has an inner peripheral end being opened. Each turn of the second winding part has a first partial winding part wound concentrically with the third winding part and a second partial winding part protruding radially outward from the first partial winding part and wound about a center axis positioned between the first partial winding part and the first winding part. With this configuration, when the second partial winding part of the second winding part is used as a coupling coil, it is possible to obtain a low self-resonance frequency and high coupling performance.

In the above antenna device, the number of turns of the third winding part may be larger than the number of turns of the first winding part. This reduces a difference in line length between the first and third winding parts, thereby allowing the second winding part including a coupling coil to be disposed at substantially the center of the line length of the first coil pattern.

In the above antenna device, the number of turns of the first winding part may be larger than the number of turns of the second winding part. This can further reduce the self-resonance frequency.

In the above antenna device, the pattern width of the first partial winding part of the second winding part may be larger than the pattern width of the second partial winding part of the second winding part. This can reduce the resistance value of the first partial winding part of the second winding part.

In the above antenna device, the pattern widths of the first and third winding parts may be smaller than the pattern width of the first partial winding part of the second winding part. This makes it easy to ensure sufficient numbers of turns of the first and third winding parts.

In the above antenna device, the first winding part, the first partial winding part of the second winding part, and the third winding part may each be constituted of a mesh-like conductor pattern. This can make the entire antenna device substantially transparent except for the second partial winding part of the second winding part.

In the above antenna device, the second partial winding part of the second winding part may be constituted of a solid pattern. This can reduce the resistance value of the second partial winding part of the second winding part.

The above antenna device may further include a second coil pattern having a fourth winding part, a fifth winding part, and a sixth winding part. The fourth winding part may be wound in a plurality of turns and have an outer peripheral end being opened and an inner peripheral end connected to the outer peripheral end of the fifth winding part. The fifth winding part may be wound in a plurality of turns and have an inner peripheral end connected to the outer peripheral end of the sixth winding part. The sixth winding part may be wound in a plurality of turns and have an inner peripheral end being opened. Each turn of the fifth winding part may have a third partial winding part wound concentrically with the sixth winding part and a fourth partial winding part protruding radially outward from the third partial winding part and wound about a center axis positioned between the third partial winding part and the fourth winding part. The first and second coil patterns may overlap each other such that the center axes of the first and fourth winding parts are misaligned and that the center axes of the third and sixth winding parts are misaligned. This can achieve a lower self-resonance frequency.

In the above antenna device, the first winding part, the first partial winding part of the second winding part, the third winding part, the fourth winding part, the third partial winding part of the fifth winding part, and the sixth winding part may each have a first section extending in a first direction and a second section extending in a second direction perpendicular to the first direction, and the first and second coil patterns may overlap each other such that the center axes of the first and fourth winding parts are misaligned in the first and second directions and that the center axes of the third and sixth winding parts are misaligned in the first and second directions. This can reduce the self-resonance frequency with a smaller misalignment amount.

In the above antenna device, the first and second coil patterns may overlap each other such that the center axis of the second partial winding part of the second winding part and the center axis of the fourth partial winding part of the fifth winding part coincide with each other. This enhances the function of the second partial winding part of the second winding part and the fourth partial winding part of the fifth winding part as a coupling coil.

In the above antenna device, the second coil pattern may be provided on the other surface of the substrate. This can further reduce the entire antenna device and prevent the occurrence of interference fringes.

An IC card according to an embodiment of the present disclosure includes any of the above-described antenna devices and an IC module overlapping the second partial winding part of the second winding part. This can achieve an IC card capable of performing communication at a lower frequency.

What is claimed is:

1. An antenna device comprising:
a substrate; and
a first coil pattern provided on one surface of the substrate,
wherein the first coil pattern has a first winding part, a second winding part, and a third winding part,
wherein the first winding part is wound in a plurality of turns and has an outer peripheral end being opened and an inner peripheral end connected to an outer peripheral end of the second winding part,
wherein the second winding part is wound in a plurality of turns and has an inner peripheral end connected to an outer peripheral end of the third winding part,
wherein the third winding part is wound in a plurality of turns and has an inner peripheral end being opened, and
wherein each turn of the second winding part has a first partial winding part wound concentrically with the third winding part and a second partial winding part protruding radially outward from the first partial winding part and wound about a center axis positioned between the first partial winding part and the first winding part.

2. The antenna device as claimed in claim 1, wherein a number of turns of the third winding part is larger than a number of turns of the first winding part.

3. The antenna device as claimed in claim 2, wherein a number of turns of the first winding part is larger than a number of turns of the second winding part.

4. The antenna device as claimed in claim 3, wherein a pattern width of the first partial winding part of the second winding part is larger than a pattern width of the second partial winding part of the second winding part.

5. The antenna device as claimed in claim 3, wherein a pattern width of each of the first and third winding parts is smaller than a pattern width of the first partial winding part of the second winding part.

6. The antenna device as claimed in claim 1, wherein each of the first winding part, the first partial winding part of the second winding part, and the third winding part is constituted of a mesh-like conductor pattern.

7. The antenna device as claimed in claim 6, wherein the second partial winding part of the second winding part is constituted of a solid pattern.

8. The antenna device as claimed in claim 1, further comprising a second coil pattern having a fourth winding part, a fifth winding part, and a sixth winding part,
wherein the fourth winding part is wound in a plurality of turns and has an outer peripheral end being opened and an inner peripheral end connected to an outer peripheral end of the fifth winding part,
wherein the fifth winding part is wound in a plurality of turns and has an inner peripheral end connected to an outer peripheral end of the sixth winding part,
wherein the sixth winding part is wound in a plurality of turns and has an inner peripheral end being opened,
wherein each turn of the fifth winding part has a third partial winding part wound concentrically with the sixth winding part and a fourth partial winding part protruding radially outward from the third partial winding part and wound about a center axis positioned between the third partial winding part and the fourth winding part, and
wherein the first and second coil patterns overlap each other such that center axes of the first and fourth winding parts are misaligned and that center axes of the third and sixth winding parts are misaligned.

9. The antenna device as claimed in claim 8,
wherein each of the first winding part, the first partial winding part of the second winding part, the third winding part, the fourth winding part, the third partial winding part of the fifth winding part, and the sixth winding part has a first section extending in a first direction and a second section extending in a second direction perpendicular to the first direction, and
wherein the first and second coil patterns overlap each other such that the center axes of the first and fourth winding parts are misaligned in the first and second directions and that the center axes of the third and sixth winding parts are misaligned in the first and second directions.

10. The antenna device as claimed in claim 8, wherein the first and second coil patterns overlap each other such that the center axis of the second partial winding part of the second winding part and the center axis of the fourth partial winding part of the fifth winding part coincide with each other.

11. The antenna device as claimed in claim 8, wherein the second coil pattern is provided on another surface of the substrate.

12. An IC card comprising:
an antenna device; and
an IC module,
wherein the antenna device comprises:
a substrate; and
a first coil pattern provided on one surface of the substrate,
wherein the first coil pattern has a first winding part, a second winding part, and a third winding part,
wherein the first winding part is wound in a plurality of turns and has an outer peripheral end being opened and an inner peripheral end connected to an outer peripheral end of the second winding part,
wherein the second winding part is wound in a plurality of turns and has an inner peripheral end connected to an outer peripheral end of the third winding part,
wherein the third winding part is wound in a plurality of turns and has an inner peripheral end being opened,
wherein each turn of the second winding part has a first partial winding part wound concentrically with the third winding part and a second partial winding part protruding radially outward from the first partial winding part and wound about a center axis positioned between the first partial winding part and the first winding part, and
wherein the IC module overlaps the second partial winding part of the second winding part.
